(19) United States
(12) Patent Application Publication
(10) Pub. No.: US 2002/0110046 A1
(43) Pub. Date: Aug. 15, 2002

(54) Fluid agitator and conditioner

(76) Inventor: James F. Robertson, Keizer, OR (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/043,653

(22) Filed: Jan. 9, 2002

Related U.S. Application Data
(60) Provisional application No. 60/262,946, filed on Jan. 19, 2001.

(51) Int. Cl. B01F 11/00

(52) U.S. Cl. 366/110; 366/209

(57) ABSTRACT

An electromechanical apparatus and method are disclosed for agitating and conditioning fluids such as paint, polish, dyes, and the like in containers. An electrical motor generates a rotational driving force, which is reduced by a pulley system and applied to a cam drive shaft. The cam drive shaft rotationally drives a drive cam, which contains an offset drive dog. The drive cam mechanically engages and cooperates with a drive block via the drive dog to convert the rotational driving motion to a driving motion having rotational and reciprocal components. This driving motion is applied to a drive shaft, which in turn is coupled to a holder for a fluid container. The driving motion induces a vortex-like action in a fluid contained in the container thereby agitating and conditioning the fluid.

### RELATED APPLICATION

This is a regular patent application which is related to and claims priority to provisional application No. 60/262,946 entitled Fluid Agitator And Conditioner naming as inventor James F. Robertson and filed Jan. 19, 2001. That application is incorporated herein by reference for all purposes as if set forth herein in full.

### BACKGROUND OF THE INVENTION

1. Field of the Invention

The invention relates to apparatus for agitating and conditioning fluids and more specifically to an electromechanical apparatus for agitating and conditioning paints, dyes, polishes and the like.

2. Statement of Related Art

Water and oil-based paints are used by hobbyists, craftsmen, artists, and others to build models, create crafts, for tole painting, and to create works of art, among other things. Similarly, cosmetologists and beauticians use colored polishes and paints to adorn finger and toe nails.

Typically, such users of fluid paints and polishes neither need nor desire large quantities of the paints and polishes they use. Large quantities tend to be expensive and difficult to store and handle. Often, only relatively small quantities are needed for application to models, crafts and the like. Additionally, at least some such paints are of a quality that render them quite expensive. Thus, it is common for such paints and polishes to be sold, purchased, used and stored in relatively small containers. A very common container, for example, is an approximately two-ounce bottle with a threaded top and cap.

Such paints and polishes typically comprise one or more constituents, such as pigments or coloring agents. These are mixed in suspension with a base such as water, oil, alcohol, some other thinner, or a combination thereof. A common characteristic of many such paints and polishes is that as they sit unused in their storage containers, the constituents tend to separate. Such separation can result in poor surface coverage, streaking, uneven coloration and other problems. Thus, it is usually desirable if not necessary before usage to agitate the paint or polish to remix the constituents. Typically, this can be done quite simply by manually shaking the small container in which the paint or polish is stored.

However, manual agitation is not always a suitable or even an available solution. Certain users suffering from arthritic conditions, carpal tunnel syndrome or other repetitive stress injuries may not be physically able to achieve adequate manual agitation. In other instances, for example some beauty shops and the like, far too many containers may require agitation on a regular basis for manual agitation to be practicable. Even when manual agitation is possible and practicable, the forces generated by manual agitation tend to be nonuniform in terms of direction and magnitude. This can lead to the undesirable introduction of air bubbles into the paint or polish.

Various electromechanical paint-shaking apparatuses have been developed over the years. However, these have tended to be directed to the agitation of large quantities of paints in relatively large volume containers such as gallon or greater cans. Such apparatuses have tended to be large and bulky, not very portable, and quite expensive. Moreover, little thought has been given to the condition in which such agitation apparatuses leave the paint or other contents of the containers. For example, such apparatuses generally provide relatively rigorous agitation that tends to introduce air bubbles into the paint, similarly to manual agitation in the case of smaller containers. In short, such paint-shaking apparatuses are generally unsuitable for use with specialty and decorative paints, polishes, and the like, which are typically stored in small volume containers, such as the two-ounce bottles referred to previously.

What is needed therefore, is an apparatus capable of and suitable for automatically agitating paints and polishes of the type typically sold and stored in relatively small containers, such as two ounce bottles, without requiring manual agitation.

There is a further need for such an apparatus that is relatively inexpensive, compact, and portable.

There is a further need for such an apparatus that agitates the contents of a container in such a fashion as to also condition the contents by reducing the introduction of air bubbles.

### SUMMARY OF THE INVENTION

The present invention is embodied in an electromechanical apparatus that provides agitation and conditioning of relatively small containers of specialty and decorative fluid paints and polishes. The electromechanical agitation and conditioning apparatus of the invention comprises a drive motor coupled to a flexible, movable container-holder. The drive motor is coupled to the container-holder by a drive reduction mechanism, an offset-cam mechanism for converting rotational drive motion to a combination linear and vertical reciprocating agitation motion, and a drive shaft. This agitation motion applied to the container produces a vortex-like agitation of the contents, which provides conditioning as well as agitation.

### BRIEF DESCRIPTION OF THE DRAWINGS

FIG. 1 is a front elevation view of a fluid container agitator and conditioner comprising a preferred embodiment of the invention.

FIG. 2 is a top plan view of the fluid container agitator and conditioner of FIG. 1.

FIG. 3 is a back elevation view of the fluid container agitator and conditioner of FIG. 1.

FIG. 4a is a side elevation view of a preferred first drive pulley.

FIG. 4b is a side elevation view of a preferred second drive pulley.

FIG. 5 is a side cutaway view of a preferred drive camshaft.

FIG. 6a is a side cutaway view of a preferred drive cam.

FIG. 6b is an end elevation view of the preferred drive cam of FIG. 6a.

FIG. 7 is a front elevation view of a preferred drive dog mechanism.

FIG. 8a is a side cutaway view of a preferred drive block mechanism.

FIG. 8b is an end elevation view of the preferred drive block mechanism of FIG. 8a.

FIG. 8c is a side elevation view of a preferred assembly of the camshaft, drive cam, drive dog and drive block of FIGS. 6b, 7, 8a and 8b.

FIG. 9a is a side cutaway view of a preferred drive block shaft.

FIG. 9b is an end elevation view of the preferred drive block shaft of FIG. 9a.

FIG. 10a is a top plan view of a preferred container holder.

FIG. 10b is a front elevation view of the preferred container holder of FIG. 10a.

FIG. 11 is a side cutaway view of a typical container graphically showing the vortex-like agitation of the container contents produced by the preferred embodiment of the invention.

### DETAILED DESCRIPTION OF THE PREFERRED EMBODIMENT

A detailed description of the presently preferred embodiment follows with reference to the drawings, in which like components are identified by like references. The following description is not intended to be limiting in nature but is rather exemplary, the scope of the invention being defined by the appended claims.

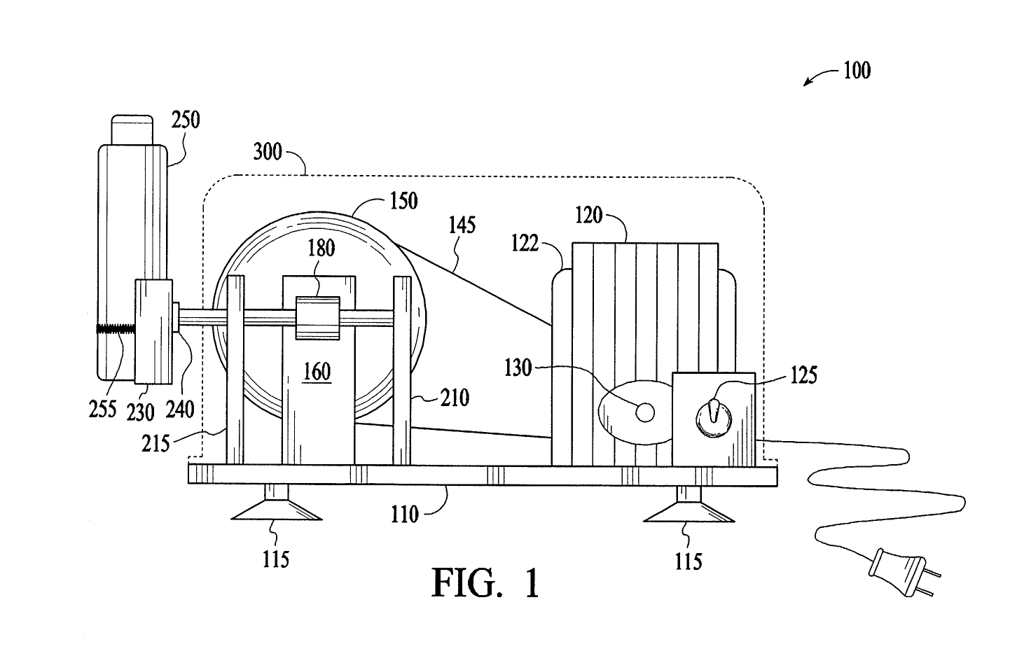

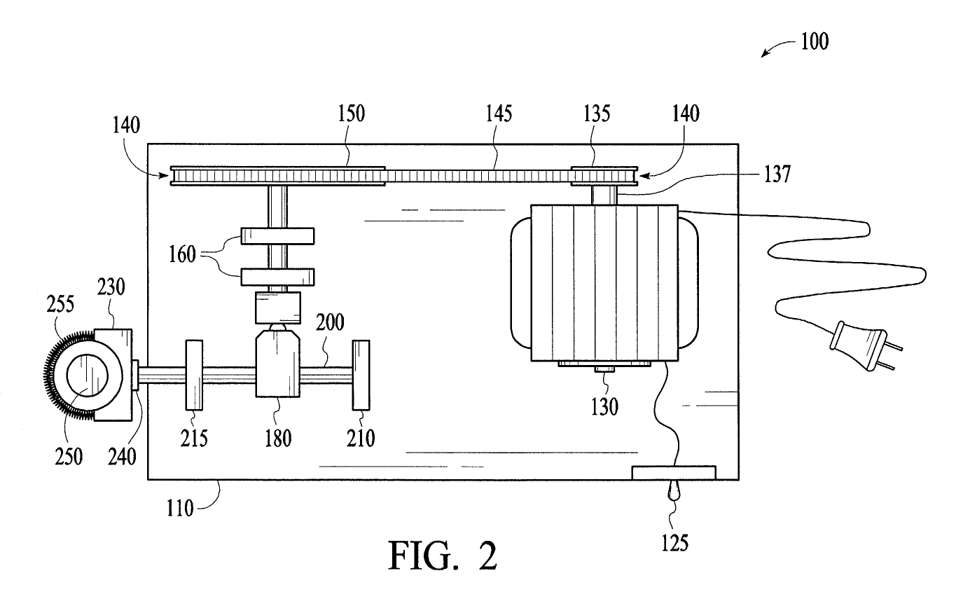

Referring to FIGS. 1-3, a fluid agitator and conditioning apparatus 100 comprising a presently preferred embodiment of the invention is illustrated. The apparatus 100 preferably comprises a compact, relatively thin, flat, rectangular base plate 110. The base plate 110 is preferably constructed of aluminum or a similar rigid, strong, but lightweight material. Soft rubber suction cups 115 are preferably mounted adjacent each of the four comers of the bottom surface of the base plate 110 to permit the base plate to be selectively, removably adhered to a support surface (not shown), such as the top of a work table or bench. The suction cups 115 may be mounted to the base plate 110 in any suitable fashion. Alternatively, soft rubber feet or the like could be used for this purpose if desired.

A drive motor 120 is preferably mounted to the top surface of the base plate 110 via a conventional motor mount 122 in any suitable fashion. The preferred drive motor 120 is relatively small and light in weight. Additionally, since the invention is specifically directed to agitation and conditioning of relatively small volumes of fluids in small containers, e.g., two-ounce bottles, it is preferred that the drive motor 120 have relatively modest output power and nominal rotation rate so as to limit the magnitude of the agitation forces applied to the relatively small containers of interest and thereby reduce or eliminate the introduction of air bubbles into the fluids being agitated. Moreover, such a motor is likely to draw less power, to be lighter in weight, and to generate less heat, vibration, and noise than more powerful industrial motors. Accordingly, the preferred motor will be more economical to operate, more compact, and less intrusive in use than typical industrial motors. A suitable motor is a C-Frame motor such as Model C01676 commercially made and sold by Precision Electric Motor Sales of Corunna, Mich. This motor provides 3000 rpm output and is rated at 0.01 horsepower at standard 115V AC operating power.

The drive motor 120 is preferably connected to and powered by a standard electrical power source such as a standard 115V wall socket (not shown). A conventional electrical switch 125 may be provided to enable the motor 120 to be manually energized and de-energized selectively without having to connect and disconnect the motor from the power source.

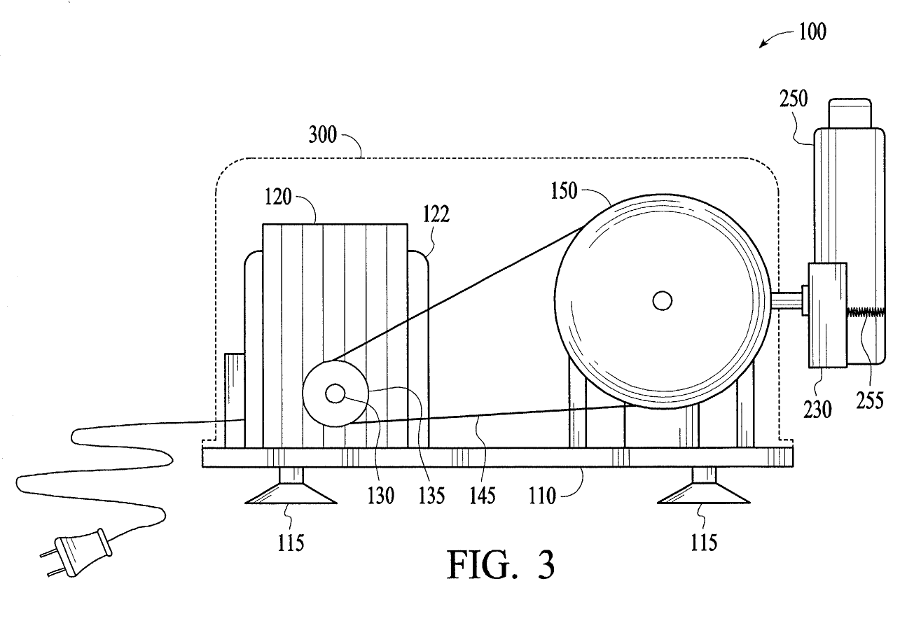

The preferred drive motor 120 has a standard drive shaft 130, which rotates at approximately 3000 rpm when the motor is energized. Mounted and secured to the drive shaft 130 is a first drive pulley 135, which is illustrated in detail in FIG. 4a. The first drive pulley 135 preferably has a bored collar 137, the bore being sized to fit over and engage the end of the drive shaft 130. The first drive pulley 135 may be mounted and secured to the drive shaft 130 in any suitable fashion, for example via a set screw arrangement through a bore in the collar 137. The first drive pulley 135 is preferably constructed of a relatively strong but light-weight material such as aluminum. In the preferred embodiment, the outer diameter of the first drive pulley 135 is approximately 0.75 inches. The first drive pulley is preferably formed with a center groove 140 which functions to engage and retain a drive belt 145. The drive belt 145 is suitably a rubber O-ring which is preferably approximately 0.093 inches in diameter and 3.25 inches outer diameter.

The first drive pulley 135 is drivingly engaged by the drive belt 145 with a second drive pulley 150, the details of which are illustrated in FIG. 4b. Similarly to first drive pulley 135, second drive pulley 150 preferably has a bored collar 152. The second drive pulley 150 is also preferably constructed of a relatively strong but light-weight material such as aluminum. The second drive pulley 150 is also preferably formed with a center groove 140 which functions to engage and retain drive belt 145. In the preferred embodiment, the outer diameter of the second drive pulley 150 is greater than that of the first drive pulley 135 in order to affect a reduction in the rate of rotation of the drive motor drive shaft 130. An outer diameter of approximately 2.0 inches has been found suitable for this embodiment and produces a reduction of approximately 3.5 times, such that the second drive pulley 150 rotates at approximately 850 rpm. First and second drive pulleys having the preferred characteristics are easily manufactured by any competent machine shop using conventional machining methods.

A drive camshaft 155, illustrated in detail in FIG. 5, preferably comprises an elongated cylindrical shaft and is manufactured of a strong, rigid, but light-weight material such as stainless steel. The drive camshaft 155 is preferably dimensioned such that one end 162 thereof fits into and is engaged by the bored collar 152 of the second drive pulley 150. A flat 163 may be provided on one side of the drive camshaft 155 near end 162 if desired to facilitate connection with the pulley 150. The end 162 of the drive camshaft 155 may be secured to the second drive pulley 150 in any suitable fashion, for example by inserting a set screw (not shown) through a bore in the collar 152 to engage the flat 163. A suitable drive camshaft is readily constructed by any competent machine shop using conventional machining methods.

The drive camshaft 155 extends outwardly from the second drive pulley 150 preferably passing through a pair of substantially identical bearing stand-offs 160. Each bearing stand-off 160, the details of which are shown in FIG. 4c, has a substantially identical circular bore 158, which is formed in and extends completely through the bearing stand-off 160. The drive camshaft 155 preferably extends through the bores 158, which are preferably dimensioned to permit free rotation of the drive camshaft 155 therein without excess play thereof. The bearing stand-offs 160 are mounted to the base plate 110 in any suitable fashion, or are integrally formed therewith, and are preferably positioned and dimensioned so that the second drive pulley 150 is substantially in line and co-planar with the first drive pulley 135. The bearing stand-offs 160 provide support for the second drive pulley 150 and the drive camshaft 155. In addition, the bearing stand-offs 160 permit the second drive pulley 150 and drive camshaft 155 to freely rotate when driven by the drive motor 120 via the first drive pulley 135 and pulley 145. To facilitate such free rotation, the bores 158 through which the drive camshaft 155 extends are preferably provided with self-lubricating bushings, for example oil-impregnated bushings such as Oil-Lite brand bushings (not shown), which are commercially available from various distributors, including McGuire Bearing Company of Salem, Oreg. The bushings are suitably inserted and held in the bores 158 by a light press or friction fit. Oil-Lite type self-lubricating bushings are preferred because they are easy to use, light-weight, inexpensive and require no lubrication. However, other alternatives such as bearing rings may be used if desired.

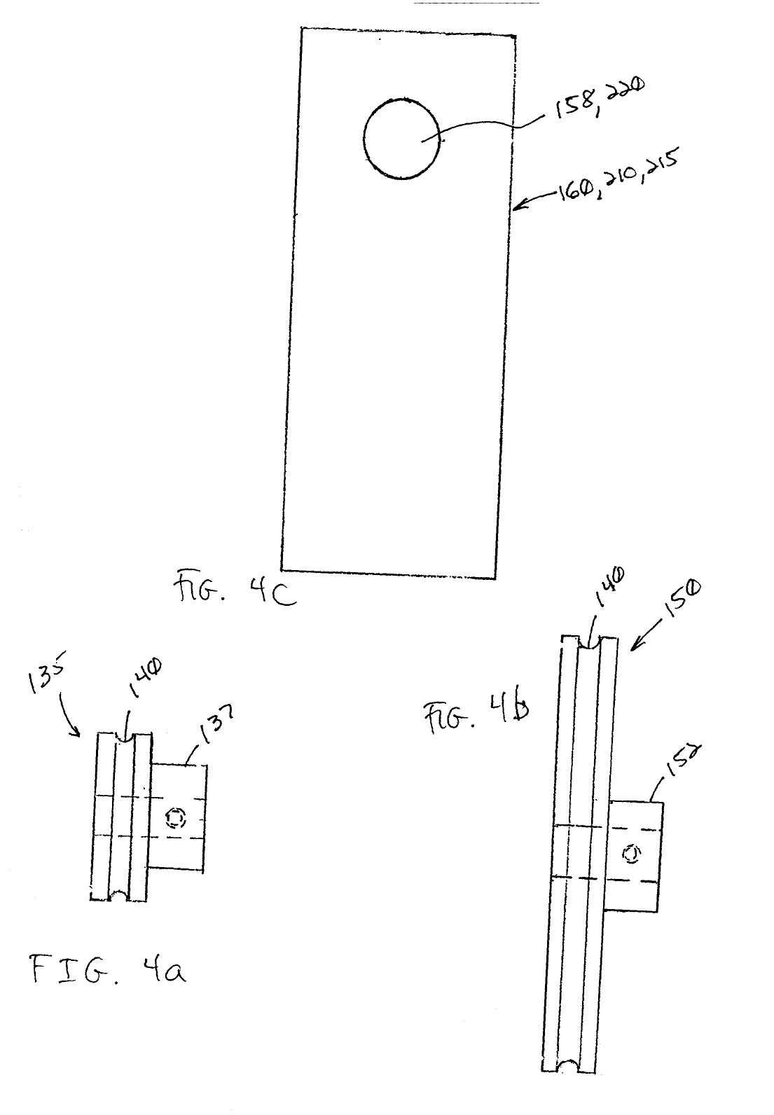

A drive cam 165, illustrated in detail in FIGS. 6a and 6b, is preferably adapted to be mounted on a second end 157 of the drive camshaft 155. The preferred drive cam 165 has a substantially cylindrically-shaped body and is constructed of a strong, rigid, but light-weight material such as stainless steel. The preferred drive cam 165 is provided with a substantially cylindrical bore 167, which is dimensioned to fit over and engage the second end 157 of the drive camshaft 165. The drive cam 165 may be secured to the second end 157 of the drive camshaft 165 in any suitable manner, for example by providing coincident bores through the side of the body of the drive cam 165 and adjacent the second end 157 of the drive camshaft 165 and securing the two with a set screw or the like. The outward face 170 of the drive cam 165 is preferably substantially circular in shape and is provided with a small threaded bore 172, which is offset from the center of the face 170.

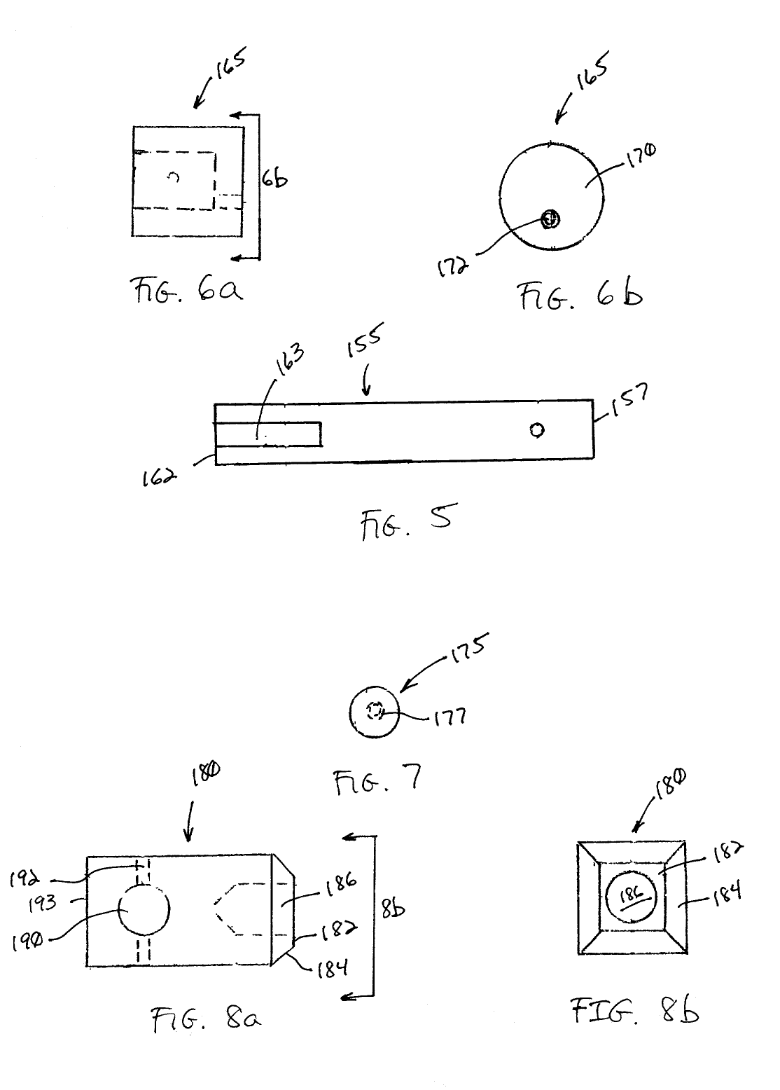

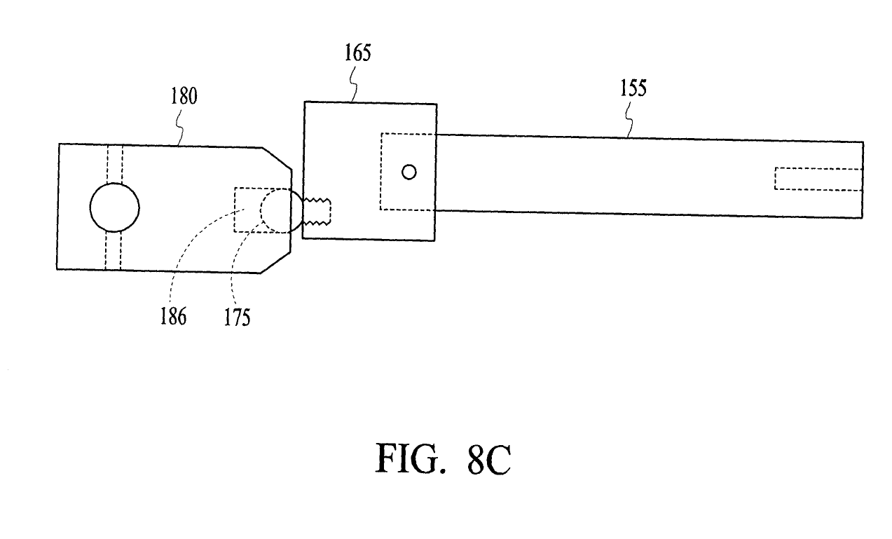

A drive dog 175, illustrated in FIG. 7, which is preferably a small spherical ball, is preferably mounted to the face 170 of the drive cam 165. The drive dog 175 is preferably mounted to the face 170 by providing a small threaded shaft 177 perpendicular to the surface of the ball. One end of a headless setscrew (not shown) is inserted in the threaded bore 172 and secured leaving the opposite end of the set screw exposed and protruding slightly beyond the surface of face 170. The threaded shaft 177 of the drive dog 175 is then screwed onto the exposed end of the set screw and tightened down so that the surface of the drive dog 175 is preferably in contact with and flush with the surface of the face 170. Because the threaded shaft 172 is offset from center of the face 170, the drive dog 175 is offset as well. The drive dog 175 functions essentially as the lobe of the drive cam 165. FIG. 8c contains a detailed illustration of the assembly of the drive camshaft 155, the drive cam 165, the drive dog 175, and a drive block 180, which is described in detail below.

In the preferred embodiment, the face 170 of the drive cam 165 is approximately 0.5 inches in diameter and the protruding drive dog 175 is an approximately 0.25 inch diameter spherical ball. The drive dog 175 is preferably manufactured of stainless steel material, stainless material being preferred for such characteristics as long wear and resistance to corrosion and material deformation. The drive dog may be readily fabricated by any competent machinist using conventional machining methods. The drive dog 175 is preferably mounted approximately 0.09 inches offset from the center of the face 170. It has been found that varying the amount the drive dog 175 is offset from the center of the cam face affects the magnitude and character of the agitation forces applied to the container to be agitated. Those skilled in the art will thus realize that while an offset of approximately 0.09 inches is presently preferred, other values of offset can certainly be used as desired without varying from the basic concepts of the invention.

Drive dog 175 is adapted to be seated in and engaged by a drive block 180, the details of which are illustrated in FIGS. 8a and 8b. Drive block 180 is preferably fabricated of a very rigid, hard material, such as brass. Like the stainless steel selected for construction of the drive dog 175, brass is preferred for fabrication of the drive block 180 due to its excellent wear characteristics, as well as its resistance to material deformation. In the preferred embodiment, the drive block 180 is formed in a substantially elongated rectangular shape. One face 182 of the drive block is preferably provided with a beveled edge 184. A bore 186 is preferably provided in the face 182 and extends partially into the body of the drive block 180 along the longitudinal axis thereof. Preferably, the bore 186 and drive dog 175 are dimensioned relative to one another such that drive dog 175 can be inserted at least partially into bore 186 but remain relatively free to move rotationally therein without significant restriction or obstruction. To facilitate free movement of the drive dog 175 relative to the drive block 180, to reduce friction between the drive dog 175 and drive block 180, and to preserve the drive dog 175 and drive block 180, it is preferred to pack the bore 186 at least partially with silicon grease.

As shown in FIG. 8c, it is preferred that the drive cam 165 and the drive block 180 are positioned relative to one another such that the face 182 of the drive block does not contact the face 170 of the drive cam. At the same time, however, it is preferred that the drive block 180 and drive cam 165 are positioned so that drive dog 175 is inserted far enough into the bore 186 that there is insufficient clearance or play for the drive dog 175 to become unseated from the bore 186 in operation.

A second bore 190 is provided in the drive block preferably nearer an end 193 of drive block opposite face 182. The second bore 190 is preferably oriented substantially transverse to the first bore 186 and, unlike the first bore, preferably extends completely through the body of the drive block. Finally, a third bore 192 is preferably provided in the body of the drive block transversely to and intersecting the second bore 190. The third bore 192 is preferably smaller in diameter than the second bore 190 and also extends completely through the body of the drive block. As with other preferred components described herein, the drive block is easily fabricated by any competent machinist using conventional machining methods.

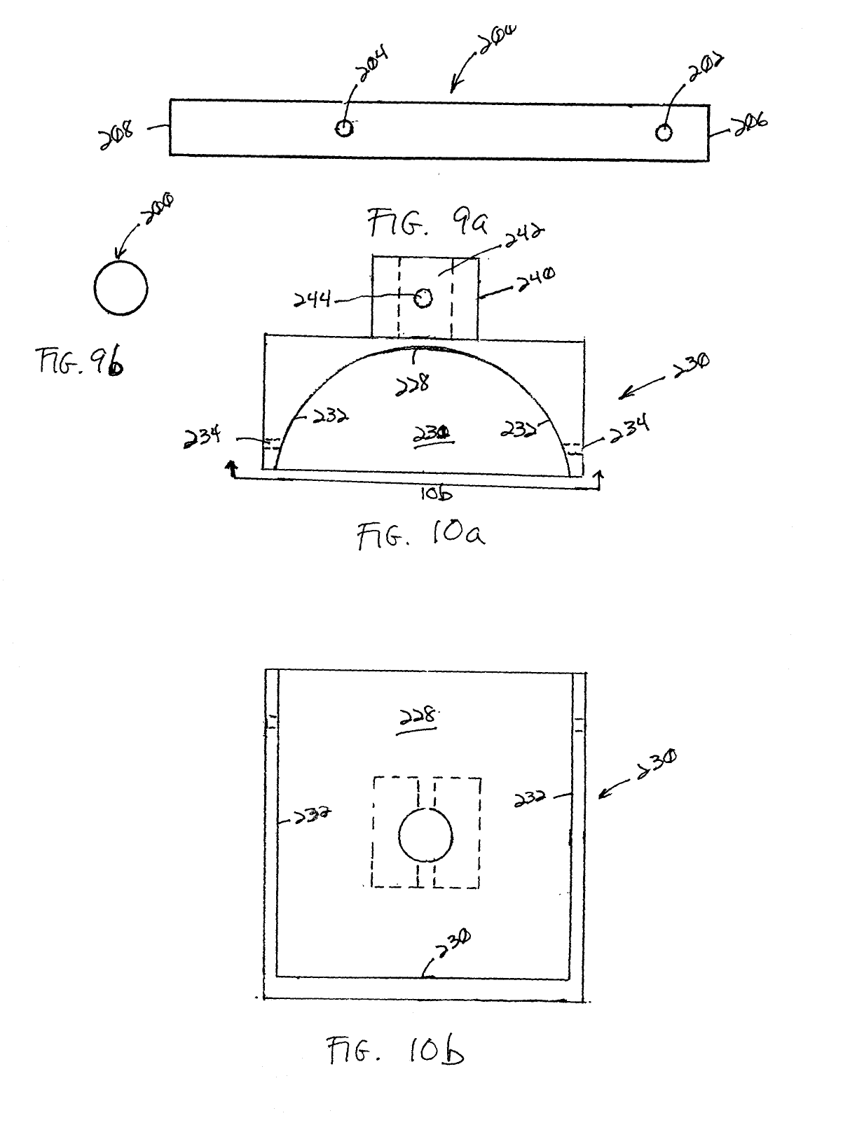

FIGS. 9a and 9b illustrate the details of a preferred form of drive block shaft 200. Drive block shaft 200 is preferably an elongated cylindrical rod fabricated of a strong, rigid material such as stainless steel. Drive block shaft 200 is preferably dimensioned to pass through and to be securely engaged in the second bore 190 of the drive block 180, it being understood that the longitudinal axis of drive block shaft 200 is thereby maintained substantially transverse to the longitudinal axis of drive block 180, the longitudinal axis of drive cam 165 and the longitudinal axis of drive camshaft 155. Drive block shaft 200 is preferably provided with two parallel bores 202 and 204, which extend transversely to the longitudinal axis of the shaft and extend completely through the shaft. One bore 202 is preferably provided adjacent a first end 206 of the shaft whereas the second bore 204 is preferably provided nearer the opposite end 208 of the shaft. The second bore 204 is preferably dimensioned essentially the same as the third bore 192 of drive block 180 so that when drive block shaft 200 is inserted through the second bore 190 of the drive block, the second bore 204 and third bore 192 can be aligned. This permits a set-screw or other suitable fastening device to be inserted through the bores 204 and 192 to fixedly engage the drive block shaft to the drive block body. Preferably, the second bore 204 is spaced from the end 208 of the drive block shaft such that at least a short section of the shaft adjacent end 208 extends outwardly from the body of the drive block 180, while a longer section of the shaft adjacent end 206 extends outwardly from the body of the drive block 180.

A pair of identical bearing stand-off supports 210 and 215 are preferably provided with a pair of identical bores 220, which extend completely through the respective bodies of the supports 210 and 215, to support the drive block 180 and drive block shaft 200. Preferably the bearing stand-offs 210 and 215 are identical to bearing stand-offs 160. The bores 220 are preferably dimensioned to receive and engage the shaft and to permit reciprocal and rotational motion of the shaft therein. In the preferred embodiment, the reciprocal motion is substantially transverse to the plane of the drive cam and drive camshaft, and the rotational motion is about the longitidunal axis of the shaft 200, which is transverse to the drive camshaft. The drive block shaft 200 has ends 206 and 208 and is preferably supported in the bores 220 such that the drive block is positioned substantially midway between the supports. One support 210 preferably engages and supports the shaft 200 adjacent end 208 and the other support 215 preferably engages and supports the shaft 200 adjacent end 206. Each of the supports 210 and 215 is secured to the base plate 110 in any suitable fashion, or integrally formed therewith. Each of the supports is preferably oriented such that the bores 220 are substantially parallel to each other, are substantially co-axial with the longitudinal axis of the drive block shaft 215, and are substantially transverse to the plane of the bore 158 of the bearing stand-off 160. The bores 220 are also preferably at substantially the same height above the base plate 110 so that they support the drive block shaft 200 substantially horizontally. Further, the bores 220 are preferably formed at the same height as the bore 158 of the bearing stand-off 160. Each of the bores 220 is preferably fitted with self-lubricating bushings, such as the Oil-Lite brand bushings previously identified, to facilitate free rotational movement of shaft 200 therein, and hence of the drive block 180 relative to drive cam 165 and drive cam shaft 155. Oil-Lite brand or similar bushings are preferred for the reasons previously described with respect to bearing stand-off 160. However, other alternatives such as bearing rings may be used for this purpose if desired.

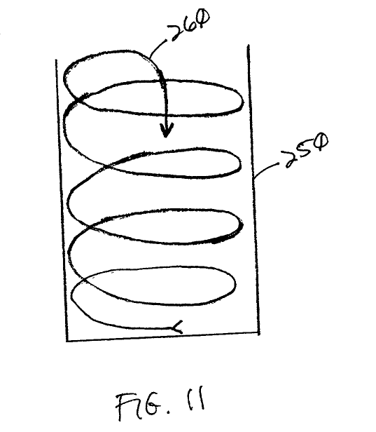

A container holder 230, the details of which are illustrated in FIGS. 10a and 10b, is preferably connected to the end 206 of the drive block shaft 200. Container holder 230 is preferably fabricated of a relatively strong, but light-weight material such as aluminum. The preferred container holder has a substantially concave vertical back surface 228, a substantially horizontal floor 231, and a pair of vertical side walls 232, which are contiguous with the back surface 228. The floor 231 preferably defines at least a portion of a semi-circle and the back surface and side surfaces define a partially enclosed cylinder (back and sides) with an open front. Together, the floor and the back and side surfaces provide a support surface and partial enclosure for a container 250, such as a cylindrical-shaped container, to be agitated. A pair of bores 234 or other fastening means are preferably provided in the side surfaces adjacent the open front of the partial enclosure to engage a container restraint. A preferred container restraint is a relatively tightly coiled spring 255, the opposite ends of which are engaged by the bores 234. The spring can be stretched as necessary to mount containers of various sizes in the container holder and the spring then acts by its natural forces to restrain the container as it is agitated. A collar 240 is integrally formed with the back surface of the container holder for connection to end 206 drive block shaft 200. The collar 240 is provided with a bore 242 having its longitudinal axis co-axial with the longitudinal axis of the shaft and dimensioned to receive and engage end 206 of the shaft. A small bore 244 is formed transversely to the longitudinal axis of the bore 242 and extends through the entire body of the collar 240. The bore 244 is preferably dimensioned and positioned so that when the end 206 of drive block shaft 200 is inserted into the bore 242, the bore 244 lines up with the bore 202 adjacent the end 206 of the shaft so that a set-screw or other suitable fastening device can be used to fixedly connect the shaft to the container holder.

A cover 300 may be provided if desired to cover and enclose the apparatus. The cover may be secured to the base plate 110 in any suitable fashion. Preferably, an opening is formed in the cover to permit the end 206 of drive block shaft 200 and the container holder 230 to extend from the enclosed space. While a cover is not strictly necessary, in some applications it may be desirable to prevent interference with moving parts of the apparatus, to reduce noise, and/or to reduce the build-up of dirt and the like on the moving parts.

Having described the structure of a preferred apparatus, attention is now turned to the operation thereof. In order to agitate and condition the contents of a container, the container is placed in the container holder 230 resting on the floor 231 thereof and restrained by the spring restraint or other suitable restraint. The power switch 125 is actuated to provide power to the drive motor 120. The drive motor 120 drives its output shaft 130 rotationally at a rate of approximately 3000 rpm's. This in turn causes the first and second drive pulleys 135 and 150 to rotate, which in turn cause the drive cam shaft 155 and drive cam 165 to rotate. Because of the rotational reduction affected by the first and second drive pulleys, however, the drive cam shaft and drive cam rotate at approximately 850 rpm's. The drive dog 175 rotates with the drive cam 165. However, since it is mounted offset from center of the face 170 of the drive cam, it rotates along a substantially circular path, the centerpoint of which corresponds with the center of face 170. The drive dog acts as the lobe of the drive cam 165. Since the drive dog 175 is partially inserted in and engaged by the drive block 180, when it rotates along its circular path, it drives drive block 180 along a continuous circular path, which includes both vertical and horizontal components of continuously varying magnitude relative to each other. Drive block 180 is free to move along this path by virtue of its support by bearing stand-offs 210 and 215. The path of motion of drive block 180, including the combination of horizontal and vertical motions, is communicated by the drive block shaft 200 to the container holder 230 and provides agitation of the contents of the container 250.

As illustrated in FIG. 11, it has been found that the unique arrangement described results in a sort of vortex like agitation of the contents of a container. Thus, it has been found that the liquid contents of a container 250 undergoing agitation by the apparatus embodying the invention tend to flow up from the bottom of the container along the sidewalls and back down through the mid-section of the container, generally in the direction of arrow 260. This vortex-like action has been found to result in superior mixing of the fluid contents, particularly where components of the contents, such as pigments, have separated after long periods of storage. In addition, the vortex-like action has been found to provide advantageous conditioning of the contents, including the suppression of air bubbles, resulting in superior coverage and quality of coverage, among other advantages.

The presently preferred embodiments and operation of an apparatus embodying the present invention have been described. Persons skilled in the art will realize from the foregoing description that numerous variations and changes can be made to the arrangement of components, materials, and the like without significantly departing from the spirit of the invention and while retaining the characteristic advantages and features thereof. The foregoing description is therefore intended to be exemplary in nature and not limiting of the scope of the invention, which is defined solely by the appended claims as properly interpreted.

What is claimed is:

1. An apparatus for agitating fluids in a container, comprising:
a motor for providing a first rotational driving force;
a drive cam coupled to said motor for receiving said first rotational driving force and converting said first rotational driving force into a second driving force having a reciprocal component;
a container holder for holding a fluid container, the contents of which are to be agitated;
a drive shaft coupled to said drive cam and to said container holder for receiving said second driving force and communicating it to said fluid container to agitate the contents thereof.

2. The apparatus of claim 1 including a drive reducer for coupling said motor to said drive cam.

3. The apparatus of claim 1 wherein said drive cam has an offset lobe, and said drive cam is coupled to said drive shaft by said offset lobe.

4. The apparatus of claim 2 including a cam shaft, and wherein said drive cam is coupled to said motor by said drive reducer and said cam shaft.

5. The apparatus of claim 1 wherein said container holder is rigidly coupled to said drive shaft.

6. The apparatus of claim 1 wherein said second driving force is operative to produce a vortex-like agitation of a fluid contained in said fluid container.

7. The apparatus of claim 1 wherein said drive cam is operative to convert said first rotational driving force into a second driving force having reciprocal and rotational components.

8. The apparatus of claim 7 wherein said second driving force is operative to produce a vortex-like agitation of a fluid contained in said fluid container.

9. A method for agitating fluids in a container, comprising:
providing a first rotational driving force;
converting said first rotational driving force into a second driving force having a reciprocal component; and
applying said second driving force to a fluid container to agitate the contents of said fluid container.

10. The method of claim 9 wherein said second driving force has reciprocal and rotational components.

11. The method of claim 9 wherein the second driving force agitates the contents of said fluid container in a vortex-like manner.

12. The method of claim 10 wherein the second driving force agitates the contents of said fluid container in a vortex-like manner.

13. An apparatus for agitating fluids in a container, comprising:
first means for providing a first rotational driving force;
second means coupled to said first means for receiving said first rotational driving force and converting said first rotational driving force into a second driving force having a reciprocal component;
third means for holding a fluid container, the contents of which are to be agitated; and
fourth means coupled to said second means and to said third means for receiving said second driving force and communicating it to said fluid container to agitate the contents thereof.

14. The apparatus of claim 13 wherein said second means includes a drive cam.

15. The apparatus of claim 14 wherein said drive cam has an offset lobe, and wherein said fourth means is coupled to said second means by said offset lobe.

16. The apparatus of claim 14 including a drive reducer and a cam shaft, and wherein said drive cam is coupled to said first means by said drive reducer and said cam shaft.

17. The apparatus of claim 13 wherein said third means includes a container holder, said fourth means includes a drive shaft, and wherein said container holder is rigidly coupled to said drive shaft.

18. The apparatus of claim 13 wherein said second driving force is operative to produce a vortex-like agitation of a fluid contained in said fluid container.

19. The apparatus of claim 13 wherein said second means is operative to convert said first rotational driving force into a second driving force having reciprocal and rotational components.

20. The apparatus of claim 19 wherein said second driving force is operative to produce a vortex-like agitation of a fluid contained in said fluid container
